(19) United States
(12) Patent Application Publication
(10) Pub. No.: US 2005/0130778 A1
(43) Pub. Date: Jun. 16, 2005

(54) Sprocket chain

(76) Inventor: Gerhard Wagner, Kressbronn (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/997,563

(22) Filed: Nov. 24, 2004

(30) Foreign Application Priority Data
Dec. 11, 2003 (DE) 103 57 850.1

(51) Int. Cl. F16G 13/02; F16G 1/21; F16G 1/22

(52) U.S. Cl. 474/206; 474/228; 474/230

(57) ABSTRACT

A sprocket chain with a plurality of links (1) pivotally bound together via pins (2). To enable the introduction of power, power input elements (5) are provided, the input elements (5) being separate from the pins (2), the end faces (6) of the input elements (5) possessing at least two contact surfaces (7) in the running direction of the sprocket chain.

The invention concerns a sprocket chain (hereinafter “chain”) in accord with the principal concept of claim 1.

Such a chain has been disclosed by DE 199 51 949 A1. The chain so disclosed possesses a plurality of links, of which two are placed parallel to one another in the travel direction of the chain and are bound together by means of link-pins. In the longitudinal extent of the chain, the links are pivotally joined with one another. The pins extend themselves transversely to the longitudinal extent of the chain. The chains serve principally as a power transfer means for stepless transmissions using V-shaped, adjustable sheaves, wherein the V-shape is brought about by placement of conical disks (hereinafter “V-disks).

The introduction of the power to be transferred by these disclosed chains is carried out by friction of contacting surfaces situated on the end facings of pins.

Within the chain, the power transmission is effected by the contact of the pins with the links. Thus, the pins receive, in the state of the technology, both the function of the transmission of the frictional force from the V-disk surfaces to the links as well as the transmission of the force carried out internally by the chain.

These known chains possess, per link, one pin. This single pin results in a relatively high Hertzian pressure between the V-disk surface and the end faces. Likewise, by means of a comparatively large linear separation of the individual pins in the travel direction of the chain, a generation of relatively high noise level is present.

Chains are also known wherein the function of the introduction of power from the V-disks to the chain as well as from the power transmission within the chain is assumed by separated components. In this respect, the links of the components separated from the pins are so arranged that these are designed in a rod-like fashion and are fastened onto the links. In this way, the pins are relieved from the axial introduced forces. The already mentioned Hertzian pressure and the unfavorable generation of noise cannot be eliminated by an arrangement such as this.

On this account, the purpose of the invention is to make a chain available, wherein first, the Hertzian pressure between those components which act to introduce power input into the chain and second, the creation of operational noise are clearly reduced.

This purpose is achieved by the features of the principal claim, while advantageous embodiments and improvements of the invention can be inferred from dependent claims.

The invention provides that at least individual links receive an element for the input of power, which element is to run transversely to the extended chain, which element, on its transversely placed end-faces, possesses at least two contact surfaces which are separated from one another in the longitudinal direction of the chain.

This has the advantage, that the Hertzian pressure on the contact surfaces of the power input element is lessened by a separation into at least two contact surfaces and by means of a lessened separating distance of two contact surfaces per link, which brings about an increase in the multiplicity of the contact surfaces against primary power source element, such as a V-disk surface, and thus the noise generation is clearly diminished.

A serviceable embodiment of the power input elements provides, that these are to consist of at least two rods, spaced from each other in the direction of chain travel. These rods can, in accordance with the demand on the contact surfaces, be provided with a circular or even with a polygonal or most advantageously, a rectangular cross-section.

Preferably the power input elements are placed on the outer ends of the links, which placement establishes a relative smaller running radius.

In another preferred embodiment, the power input elements are designed to be rod-like elements, which are inset within openings in the links and extend themselves accordingly in a transverse direction beyond the link pins. In such a case, the preference is that the power input elements also have recesses, which are designed to be groove-like and open on one side. External, groove-complementary power source elements can easily mesh with the power input elements of the chain.

To achieve an even greater lowering of noise radiation, advantageously, provision can be made that the separating distance between contact surfaces assigned to one chain link is to differ from the corresponding separating distance from another contact surface. In this way it is possible with corresponding construction, to create statistically, irregularly interspersed contacts of the surfaces in, for example, of V-disk sheaves. This design also creates less noise emission.

In a particularly advantageous manner, the at least two contact surfaces of the power input element can be made by the cutting of at least one groove into the open and contacting face thereof. In connection hereto, an asymmetrically placed groove now produces two contact surfaces, which differ in their dimensioning, and this, once again, leads to a diminishment of the noise level. In this way, the power input element can exhibit a transversely extending cross-section in the area of the first of the two contact surfaces, which differs from the length in the area of the second neighboring contact surface.

In general, the reduction of the noise is improved by the cited unequal apportionments, positioning, and widths of the rods, i.e., the width of the contact surfaces. A reduction in the diameter, in other words, a lessening of the height of the rods, would achieve a desired reduction to the smallest possible running radius.

The functioning of link pins and power input elements in connection with the increased number of acting contact surfaces, enables a different apportionment of links and power input elements. An increased link apportionment permits the application of multiple pins per chain link.

Further features and advantages of the invention are to be found in the following, with the aid of a schematic drawing of an embodiment allowing a more detailed explanation of the invention. There is shown in:

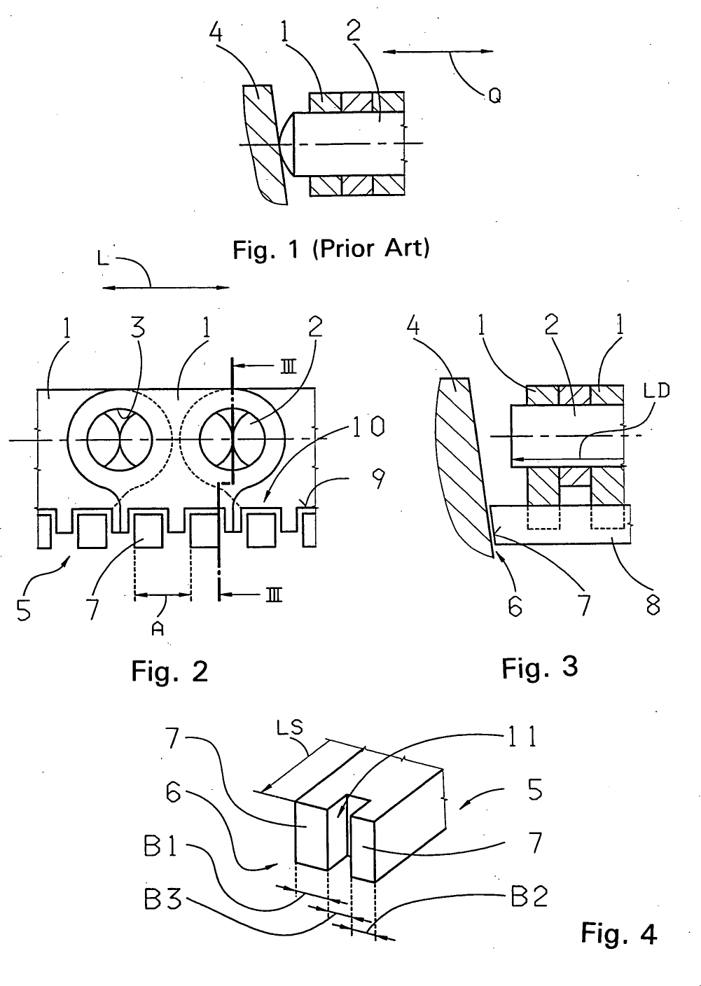

FIG. 1 is a section of a link, in accord with the state of the technology;

FIG. 2 is a side view of a chain in accord with the invention;

FIG. 3 is a section along the line III-III of FIG. 2; and

FIG. 4 is a perspective view of a power input element with an exposed face.

A chain consists of chain links 1, which are pivotally bound together in a longitudinal extension, in this case, identical with the direction of chain travel, by means of pins 2. Three parallel links 1, which are placed in the chain-travel direction, are penetrated by pins 2, which pins extend in a transverse direction Q. These pins 2 are contained in corresponding openings 3 of the link 1.

In the case of a known chain in accordance with FIG. 1, the introduction of power into a stepless, adjustable-V-disc drive is carried out, in that, between an adjustable V-disk surface 4 and the pin 2, the power is generated in terms of friction. These pins 2 also transmit power to the internal chain elements.

The adjustable V-disc sheave rotates, when operating about an axis (not shown), but would lie in reference to the plane of the drawing underneath FIG. 1.

The invented chain in accordance with FIGS. 2 and 4, operates in conjunction with power input elements 5 which are separate from the pins 2. Outward extended, end faces 6 of the power input element 5 extended outward in the transverse direction Q, are designed to be contact surfaces 7 functioning against the V-disk 4.

The power input elements 5, in accordance with FIG. 2, are designed as rods 8, which are separated from one another by a space A in a chain-travel direction L, whereby each link 1 is assigned two rods 8 with a rectangular cross section.

For the securement of the rods 8 on the chain, the links 1 are shown as being open on one side and provided with a receiver 10 cut-away which forms a groove like recess 9. In this way, these recesses 9 are placed in relation to two mutually corresponding chain links 1 which are united with a pin 2. A measured length LS in the transverse direction Q of the rod 8 is greater in measurement than a length LD of the pin 2.

In accordance with FIG. 4, it is possible that, instead of two separated rods 8 per chain link 1, only one need be used, carrying with it, its groove 11 in its end face 6. In this embodiment this groove 11 is so symmetrically excised in the face 6 that the two thus created contact surfaces 7 per power input element 5 are of different sizes. In this way there is created, in the direction of chain-travel, namely L (FIG. 2), differently sized widths B1 and B2 per contact surface 7. The total available power input, per power input element 5, is determined by the areas of the contact surfaces 7 with consideration to a width B3 of the groove 11 and the number of grooves 11 per face 6.

In the operation of the chain, the V-disk 4 rotates about its axis (axis not shown) and conducts the power to be transmitted by means of friction generated between the V-disk 4 and the contact surface 7.

The power input elements 5 lie, in reference to the V-disk axis, further inward than do the pins 2 and thereby exhibit a smaller radius of run.

The power input elements 5, however, can also be placed on the outside of the link 1 and possess, in that manner, a greater running radius than the pressure pieces 2.

### Reference Numerals

1 chain link, i.e., “link”
2 link pin, i.e., “pin”
3 opening
4 V-disk, one of two of an adjustable V-sheave
5 power inlet element
6 face, here end face of power inlet element 5
7 contact surface, see FIG. 6
8 rod, the full length of 5, see FIGS. 2, 3
9 recess in link l
10 receiver, recess 9 to accommodate rod 8
11 groove in 6
A separating distance
L extension of length
Q transverse direction
LS length
LD length
B1 width, see FIG. 4
B2 width
B3 width

1-7. (canceled)

8. A sprocket chain with a plurality of chain links (1) bound together by a plurality of pins (2), whereby the pins (2) run transversely to a longitudinal extension (l) of said chain and being supported by at least two links (1), the chain being suitable for an adjustable V-shaped sheave of a stepless transmission, one power input element (5) is placed, transversely to the longitudinal extension (L), to at least one link (1) which possesses, on an externally transversely (Q) situated face (6), at least two contact surfaces (7) which are separated from one another in the direction of the longitudinal extension (L).

9. The sprocket chain according to claim 8, wherein the power input element (5) for each of the plurality of links (1) comprises of at least two rods (8) which are separated from one another in the direction of the longitudinal extension.

10. The sprocket chain according to claim 8, wherein a separating distance (A) between the at least two contact surfaces (7) of one link (1) differs from the separating distance (A) between two other contact surfaces (7) of another link (1).

11. The sprocket chain according to claim 8, wherein at least two links (1) assigned to one pressure piece (2) possess receiver recesses (10) for the power input element (5).

12. The sprocket chain according to claim 11, wherein the receiver recesses (10) are constructed respectively with one side being an open, groove-like recess (9).

13. The sprocket chain according to claim 8, wherein the power input element (5) is bar shaped with at least one groove (11) incised into each end face.

14. The sprocket chain according to claim 13, wherein the groove (11) separates the end face (6) into two contact surfaces (7) dimensionally differing from one another.
